(19) United States
(12) Patent Application Publication
(10) Pub. No.: US 2006/0065410 A1
(43) Pub. Date: Mar. 30, 2006

(54) Method and apparatus for pre-punched pad for horsehoes

(76) Inventor: Andrew G. Stump, Fallston, MD (US)

Correspondence Address: Royal W. Craig;Law Offices of Royal W. Craig, Suite 153, 10 N. Calvert Street, Baltimore, MD, 21202, US

(21) Appl. No.: 11/239,263

(22) Filed: Sep. 29, 2005

Related U.S. Application Data
(60) Provisional application No. 60/614,114, filed on Sep. 29, 2004.

(51) Int. Cl. A01L 7/00

(52) U.S. Cl. 168/26

(57) ABSTRACT

A horseshoe pad with apertures pre-defined during manufacture. The pre-defined apertures line up with the apertures in the horseshoe to enable the farrier to nail the horseshoe through the apertures in the pad and into the hoof without tearing, moving or deflecting the pad, which may lead to undue discomfort in the horse's hoof. The pad may be pre-applied to the horseshoe or attached to the horseshoe during shoeing. The pad may be made of leather, rubber or other synthetic material, such as urethane or PVC, and may be manufactured using a cutting die, cast mold, or injection molding process

### CROSS REFERENCE TO RELATED APPLICATIONS

The present application derives priority from U.S. Provisional Patent Application 60/614,114 filed Sep. 29, 2004.

### BACKGROUND OF THE INVENTION

1. Field of the Invention

The present invention relates to horseshoe pads and, more particularly, to a horseshoe pad that is pre-punched with apertures when manufactured.

2. Description of the Background

The primary purpose of a horseshoe is to protect the horse's hoof from injury and to protect the horse itself from injury related to shock. Metal horseshoes have been used for many years to protect the horse's hoof from wear and injury and to evenly distribute the load carried by the horse. Although the most common material for horseshoes is steel, horseshoes may be made of rubber, plastic, aluminum, titanium, and other materials. To further protect the horse's hoof and cushion the hoof from the horseshoe itself, pads may be placed between the hoof and the shoe. Pads may be either full or rim, where the full pad covers the entire sole of the hoof and the rim pad covers only the area immediately beneath the shoe, such that it is relatively the same shape as the horseshoe, i.e., a U-shape. Pads vary in thickness, may be soft or hard, and are made of various types of material, such as rubber, urethane, plastic, PVC, and other materials. Pads may be formed of a solid material that is cut to fit the shape of the horseshoe or may be made of a liquid material poured into a mold, which solidifies during a curing process.

Horseshoes, horseshoe systems, and horseshoe pads are well documented in the prior art. For example, U.S. Pat. No. 5,029,648 to Stephens discloses a method and apparatus for protecting the hooves of a horse from concussive forces comprised of woven felt fixedly secured between the horse's hoof and a horseshoe. The pad is first attached to the horseshoe by rivets inserted through openings in the horseshoe and then both the pad and horseshoe are attached to the hoof via nails through openings in the horseshoe. U.S. Pat. Nos. 5,289,878 and 5,509,484 to Landi, et al. each disclose a horseshoe impact pad comprised a molded base of urethane material or the like with a resilient honeycomb panel fixedly secured to the base. Landi, et al. '484 also discloses two sheets of resilient material bonded to either side of the honeycomb panel to form a plurality of hermetically sealed cells, which pad absorbs shock that may otherwise be transmitted to the hoof. The pad is positioned between the shoe and the hoof during the shoeing process and is secured in place by horseshoe nails driven through the horseshoe slots and through the pad into the hoof.

U.S. Pat. No. 5,303,777 discloses a padded horseshoe and method that utilizes reinforced belting material as padding. The horseshoe is adhesively bonded to the reinforced belting material and the horseshoe is then applied to the horse's hoof by nailing the horseshoe through nailing holes of the horseshoe through the pad and into the hoof. U.S. Pat. Nos. 5,205,363 and 5,320,184 to Noffsinger each disclose a cushioned horseshoe comprising a mounting plate with a plurality of interlocking channel members, wherein one of the channel members includes a plurality of longitudinal locking rib members, whereby a nail may be driven through the horseshoe to engage each locking member. A ground engaging sole member of a non-slip resilient material is fixedly attached to the mounting plate during the molding process. U.S. Pat. No. 5,538,083 to Vindriis discloses a horseshoe arrangement comprising a body which is provided with holes for nails, a wearing plate with means for attachment to the body and wearing soles with means for attachment to the body and wearing plate.

Although all of the aforementioned examples address horseshoe pads and/or horseshoe pads and horseshoe configurations, they primarily address the composition of the pad and/or pad/shoe configuration and do not simplify the nailing of the horseshoe through the pad and into the hoof.

Traditionally, horseshoes with pads assembled at the factory have been problematic for farriers because the pads tend to deflect the horseshoe nail as it is driven through the aperture in the horseshoe and into the surface of the pad before entering the hoof. Moreover, when driving the nail through the service of the pad, pieces of the pad often break off and are nailed into the horse's hoof causing soreness and discomfort in the horse's hoof, which may lead to lameness of the horse.

Therefore, it would be advantageous over the prior art to provide a horseshoe pad, which pad is positioned between the horseshoe and the horse's hoof to create a cushion and protect the hoof from the horseshoe, that is made with pre-defined apertures when manufactured, these pre-defined apertures being indexed to the apertures in the horseshoe, to allow the nail to be easily and accurately driven through the aperture in the shoe, and directly through the aperture in the pad and into the hoof. The pre-defined pad may be pre-applied to the horseshoe via laminating, riveting, mold casting or injection mold manufacturing process, or may be applied to the horseshoe during shoeing via adhesive or lamination. The present invention includes the pre-defined pad and method of manufacture.

### SUMMARY OF THE INVENTION

It is, therefore, the primary object of the present invention to provide a method and apparatus for application of a pre-defined horseshoe pad to a standard horseshoe.

It is another object of the present invention to provide a pre-defined horseshoe pad with holes indexed to apertures in the horseshoe, allowing the farrier to cleanly and neatly drive the nail through the apertures in the horseshoe, and directly through the apertures in the pad and into the horse's hoof.

It is another object of the present invention to provide a pre-defined horseshoe pad that prevents the deflection of the nail as it is driven into the horseshoe.

It is another object of the present invention to provide a pre-defined horseshoe pad that allows the farrier accurate placement of the nail.

It is still another object to provide a pre-defined horseshoe pad that allows the clinches to remain tighter because the pad material is not dragged along with the nail into the hoof.

It is another object to provide a pre-defined horseshoe pad that decreases pressure on the sole of the horse's hoof.

It is yet another object to provide a pre-defined horseshoe pad that may be pre-applied to the horseshoe.

It is another object to provide a pre-defined horseshoe pad that may be attached to the horseshoe during shoeing.

It is still another object to provide a pre-defined horseshoe pad that is economical to manufacture.

The above objects are accomplished by providing a horseshoe pad with apertures pre-defined during manufacture, which pad is placed between the horseshoe and horse's hoof to cushion the horse's hoof from the horseshoe. The pre-defined apertures of the pad are indexed to and line up with the apertures in the horseshoe to enable the farrier to nail the horseshoe through the pad and into the hoof by driving the nail through the apertures in the horseshoe and directly through the apertures in the pad and into the horse's hoof, without tearing, moving or deflecting the pad, which may lead to undue discomfort in the horse's hoof. The pad may be pre-applied to the horseshoe or attached to the horseshoe during shoeing. The pad may be made of leather, rubber or other synthetic material, such as urethane or PVC, and may be manufactured using a cutting die, cast mold, or injection molding process.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a bottom plan view illustrating the pre-defined horseshoe pad of the present invention.

FIG. 2 is a horizontally exploded side perspective view illustrating the pre-defined horseshoe pad of FIG. 1 with the pre-defined apertures aligned with the apertures in a horseshoe.

FIG. 3 is a perspective view of the horseshoe pad 10 attached to the horseshoe 50 during the manufacturing process

FIG. 4 is a cross-sectional view of the pre-defined horseshoe pad of the present invention with attached horseshoe as in FIG. 3.

### DETAILED DESCRIPTION OF THE PREFERRED EMBODIMENTS

The present invention a pre-defined horseshoe pad with holes indexed to apertures in the horseshoe, allowing a farrier to cleanly and neatly drive the nail through the apertures in the horseshoe, and directly through the apertures in the pad and into the horse's hoof. This configuration provides more protection and comfort to a horse's hoof because the horseshoe pad is positioned between the horseshoe and the horse's hoof, and the pre-defined apertures in the horseshoe pad line up with the apertures in the horseshoe and allow the farrier to neatly and cleanly nail the shoe and pad to the horse's hoof, preventing slippage of the pad and/or excess pad material being nailed into the hoof, which would create undue pressure and/or soreness on the sole of the hoof.

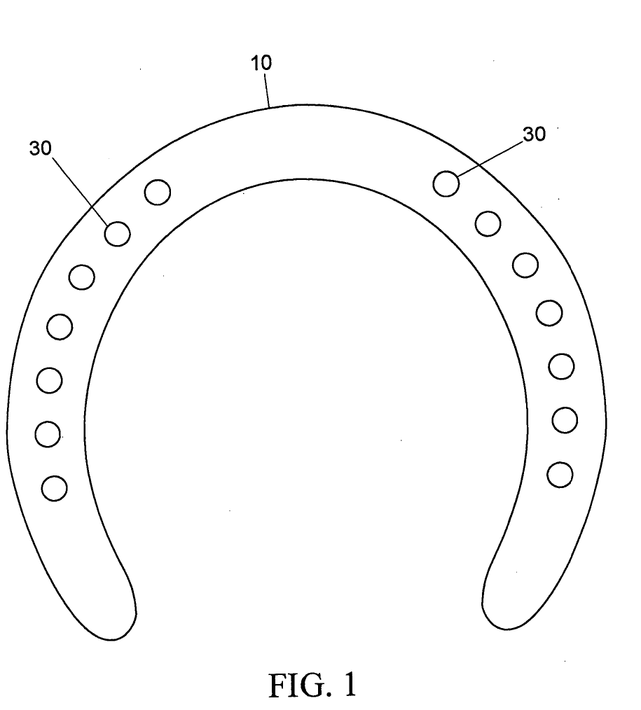

Referring to FIG. 1, the improved pre-defined horseshoe pad 10 is shown. Pad 10 may be made of any firm resilient material, such as leather, rubber, urethane, polyvinyl chloride, plastic or the like, and is formed or cut in a traditional U-shape. The thickness of the pad varies depending upon the use of the horse, and may range from ⅛ inch to ⅝ inch. A plurality of apertures 30 are pre-defined in the body of the horseshoe pad 10 at the time of manufacture of the pad. The number of pre-defined apertures corresponds in number and in position to the apertures provided in a pre-determined horseshoe as supplied by an existing horseshoe manufacturer, the number generally ranging between 8 and 14 and substantially evenly-spaced about the body of the horseshoe. Preferably, the pre-defined apertures 30 in the pad 10 are slightly larger than the apertures 40 in the horseshoe 50 to help minimize compression movement of the pad 10.

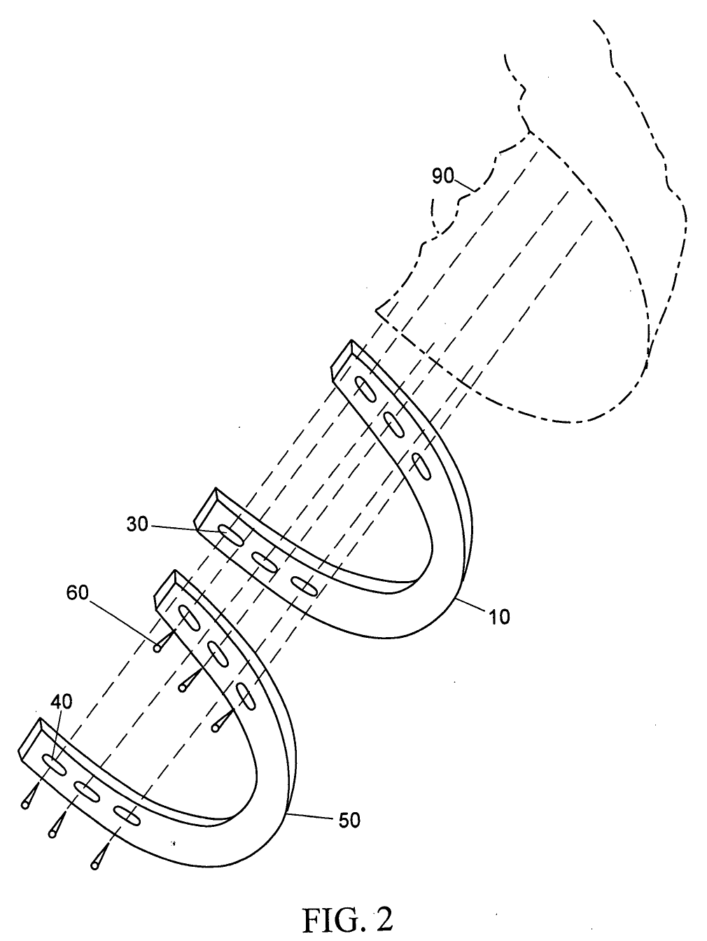

FIG. 2 is a horizontally exploded side perspective view illustrating the pre-defined horseshoe pad 10 of FIG. 1 with the pre-defined apertures 30 aligned with the apertures 40 in a horseshoe 50. The horseshoe pad 10 may be attached to the horseshoe at the factory such that the farrier may nail the horseshoe and pad 10 to the horse's hoof as an integral unit. Alternatively, the pad 10 may be supplied separately from the horseshoe and nailed between the horseshoe and hoof during shoeing. In both cases the nails 60 can be cleanly driven by the farrier through the apertures 40 in the horseshoe 50 and through the apertures 30 in the pad 10 and into the horse's hoof 90.

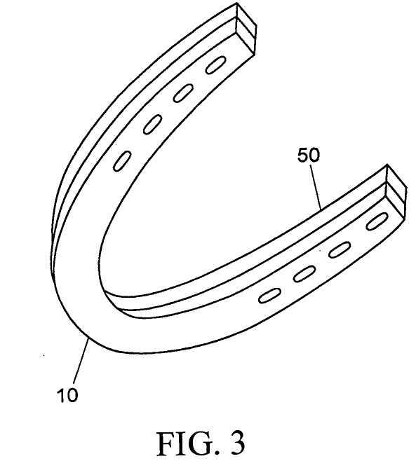

FIG. 3 is a perspective view of the horseshoe pad 10 attached to the horseshoe 50 during the manufacturing process either by mold casting or injection molding creating an integral unit such that the apertures in the pad 10 are aligned with the apertures in the horseshoe 50.

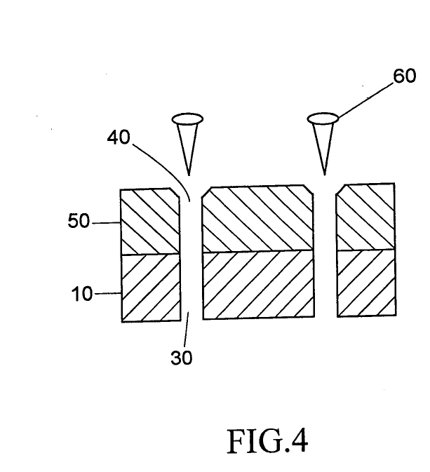

FIG. 4 is a cross-sectional view of the pre-defined horseshoe pad 10 of the present invention with attached horseshoe as in FIG. 3.

The horseshoe pad 10 of the present invention may be manufactured by three alternative manufacturing methods. The first method employs a cutting die formed in a U-shaped/horseshoe configuration with cutting teeth for the apertures pre-formed in the die. The cutting teeth of the die are aligned with the apertures in a predetermined horseshoe provided by a given manufacturer. In this case the die is used to cut the pad 10 from a sheet of suitable material, whereby the cutting teeth of the die form the apertures 30 pre-formed in the pad 10. The resulting horseshoe pad 10 is a stand-alone component with pre-defined apertures 30, which apertures are aligned with the apertures in the horseshoe. Upon shoeing, the farrier simply aligns the apertures 30 in the horseshoe pad 10 with the apertures 40 in the horseshoe 50 and then attaches the pad 10 to the horseshoe 50 by adhesive or laminate. The farrier then positions the horseshoe pad 10 next to the horse's hoof, sandwiched between the horseshoe 50 and the horse's hoof, and the nails are neatly and cleanly driven through the apertures 40 in the horseshoe 50, through the apertures 30 in the pad 10 and into the horse's hoof. Alternatively, the manufacturer may align the apertures 30 in the horseshoe pad 10 with the apertures 40 in the horseshoe 50 and attach the pad 10 to the horseshoe by adhesive or laminate at their factory. In this case, the farrier need only position the horseshoe with combined pad 10 next to the horse's hoof, and again the nails are neatly and cleanly driven through the apertures 30, 40 in the horseshoe 50 and pad 10, respectively, and into the horse's hoof.

The second method of manufacture is a casting horseshoe mold in a U-shape with pins or spacers inserted in the mold to create the nail apertures 30. Preferably, the mold is an open mold fixedly attached to the horseshoe 50 during pouring, and the pins or spacers are aligned with the apertures 40 of the horseshoe 50, so that the cast is poured in liquid form directly onto the horseshoe 50. This results in an integral horseshoe 50 and horseshoe pad 10 configuration in which the pad 10 exactly conforms to the horseshoe 50. When the liquid cures, the spacers or pins are removed. The integral horseshoe 50 and horseshoe pad 10 combination may be nailed to the horse's hoof as a single unit, such that the farrier places the pad side of the integral unit against the horse's hoof and neatly and cleanly drives the nails through the aligned apertures 40 in the horseshoe 50 and the apertures 30 in the pad 10 and into the horse's hoof.

The third method of manufacture of the present invention is an injection molding process wherein spacers or pins are inserted in the mold to form the apertures and plastic is injected into the mold, which is attached to a horseshoe, resulting in an integral horseshoe and horseshoe pad configuration. Again, it is preferred that the injection mold be fixedly attached to the horseshoe 50 during pouring so that the pad 10 exactly conforms to the horseshoe 50. When the plastic cures, the spacers or pins are removed. As with the previous method of manufacture, the integral horseshoe 50 and horseshoe pad 10 are nailed to the horse's hoof as a single unit, such that the farrier places the pad side of the integral unit against the horse's hoof and neatly and cleanly drives the nails through the aligned apertures in the horseshoe and apertures in the pad unit and into the horse's hoof.

The improved apparatus and alternative fabrication methods described above improves the comfort and alleviates the pressure on the horse's soles, while improving the quality of the farrier's shoeing by eliminating tearing of the pad, random insertion of pieces of the pad in the horse's hoof and the resulting discomfort of the horse.

Having now fully set forth the preferred embodiment and certain optional modifications of the concept underlying the present invention, various other embodiments as well as certain variations and modifications of the embodiment herein shown and described will obviously occur to those skilled in the art upon becoming familiar with said underlying concept. It is to be understood, therefore, that the invention may be practiced otherwise than as specifically set forth in the appended claims.

I claim:

1. A horseshoe pad having a pre-defined array of holes corresponding in number and position to a plurality of holes formed in an existing horseshoe, comprising:
a generally U-shaped pad formed of firm, resilient material and having opposing arms;
a plurality of pre-defined apertures formed in each arm of said U-shaped body, the number of said pre-defined apertures equaling the number of said plurality of holes formed in the existing horseshoe, and the position of said pre-defined apertures corresponding to a position of said plurality of holes formed in the existing horseshoe;
whereby said pad is applied by positioning between said horseshoe and the horse's hoof such that said pre-defined apertures align with the apertures in said horseshoe, thereby allowing nails to be inserted cleanly through both the pad and horseshoe via the apertures, and into a horse's hoof.

2. The pre-defined pad for horseshoes according to claim 1, wherein said pad is formed of rubber.

3. The pre-defined pad for horseshoes according to claim 1, wherein said pad is formed of urethane.

4. The pre-defined pad for horseshoes according to claim 1, wherein said pad is formed of polyvinyl chloride.

5. The pre-defined pad for horseshoes according to claim 1, wherein said pad is formed of plastic.

6. The pre-defined pad for horseshoes according to claim 1, wherein said pre-defined apertures are slightly larger than the apertures in the horseshoes to minimize compression movement of the pad.

7. The pre-defined pad for horseshoes according to claim 1, wherein said pad is created from die-cutting a sheet of pad material in a U-shaped formation with predefined apertures therein.

8. The pre-defined pad for horseshoes according to claim 1, wherein said pad is created by molding using a mold attached to said horseshoe, and pins inserted into said mold to form said apertures, whereby liquid material is poured into said mold, creating an integral pad and horseshoe configuration.

9. The pre-defined pad for horseshoes according to claim 1, wherein said pad is created from an injection mold attached to said horseshoe, and a plurality of pins inserted into said mold to form said apertures, whereby liquid material is injected into said mold, creating an integral pad and horseshoe configuration.

10. The pre-defined pad for horseshoes according to claim 7, wherein said pad is attached to said horseshoe during shoeing via adhesive, lamination or riveting.

11. A pre-defined pad for horseshoes, comprising:
a generally hoof-shaped body of firm, resilient material;
a plurality of pre-defined apertures in said hoof-shaped body;
whereby said pre-defined pad is positioned between said horseshoe and the horse's hoof and said pre-defined apertures align with the apertures in said horseshoe to enable nails to be inserted cleanly and efficiently through the apertures in the horseshoe, through the apertures in said pad and into the horse's hoof.

12. The pre-defined pad for horseshoes according to claim 11, wherein said pad is formed of rubber.

13. The pre-defined pad for horseshoes according to claim 11, wherein said pad is formed of urethane.

14. The pre-defined pad for horseshoes according to claim 11, wherein said pad is formed of polyvinyl chloride.

15. The pre-defined pad for horseshoes according to claim 11, wherein said pad is formed of plastic.

16. The pre-defined pad for horseshoes according to claim 11, wherein said pre-defined apertures are slightly larger than the apertures in the horseshoe to minimize compression movement of the pad.

17. The pre-defined pad for horseshoes according to claim 1, wherein said pad is created from a cutting die in a hoof-shaped formation with predefined apertures.

18. The method and apparatus for a pre-defined pad for horseshoes according to claim 17, wherein said pad is attached to said horseshoe during shoeing by any one of adhesive, lamination or riveting.

19. A method of manufacturing a pre-defined pad for horseshoes, comprising the steps of:
creating a cutting die formed in a U-shaped configuration,
creating cutting teeth for the apertures pre-formed in the die,
aligning the cutting teeth of the die with the apertures in a predetermined horseshoe provided by a given manufacture,
using the die to cut a horseshoe pad from a sheet of horseshoe pad material,
whereby said cutting teeth of the die form the apertures pre-formed in the horseshoe pad and the resulting horseshoe pad is a stand-alone component with pre-defined apertures, which apertures are aligned with the apertures in the predetermined horseshoe.

20. A method of applying a predefined pad for a horseshoe, comprising the steps of:
aligning the apertures in the predefined horseshoe pad with the apertures in a predefined horseshoe,
attaching said pad to said horseshoe by adhesive or laminate,
positioning said horseshoe pad next to the horse's hoof, sandwiched between the horseshoe and the horse's hoof,
driving nails through said apertures in the horseshoe through said apertures in said pad and into the horse's hoof.

21. A method of manufacturing a pre-defined pad for horseshoes, comprising the steps of:
casting a horseshoe mold in a U-shape,
fixedly attaching said mold to a horseshoe during pouring,
inserting spacers or pins into said horseshoe-shaped mold to align with the apertures in said horseshoe,
pouring the casting liquid form directly onto said horseshoe,
removing the spacers or pins when the liquid cures, creating apertures in the cured liquid,
whereby said combined horseshoe and cured liquid is a horseshoe with attached horseshoe pad with aligned apertures, such that a farrier may insert nail through the apertures in the horseshoe, and through the apertures in the horseshoe pad and into the horse's hoof. unit and into the horse's hoof.

22. A method of manufacturing a pre-defined pad for horseshoes, comprising the steps of:
creating a horseshoe-shaped mold,
attaching said horseshoe-shaped mold to a horseshoe,
inserting spacers or pins into said horseshoe-shaped mold to align with the apertures in said horseshoe,
injecting plastic into said horseshoe-shaped mold,
removing said spacers or pins when said plastic cures, creating apertures in the cured plastic,
whereby said combined horseshoe and plastic is a horseshoe with attached horseshoe pad with aligned apertures, such that a farrier may insert nail through the apertures in the horseshoe, and through the apertures in the horseshoe pad and into the horse's hoof. unit and into the horse's hoof.
